(19) United States
(12) Patent Application Publication
(10) Pub. No.: US 2006/0093100 A1
(43) Pub. Date: May 4, 2006

(54) Telephone customer service through transmission of interactive menu

(75) Inventors: Michael Pierre Carlson, Austin, TX (US); Linda Arnold Lisle, Cedar Park, TX (US); Herman Rodriguez, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/981,273

(22) Filed: Nov. 4, 2004

(51) Int. Cl. H04M 11/00

(52) U.S. Cl. 379/88.16; 379/88.18

(57) ABSTRACT

Transmission of interactive menus that include a user's requesting, by a call to a call service, a service of the call service, the call service including services, a voice response system, and one or more interactive menus; receiving in a telecommunication device from the call service an interactive menu, including suspending the requested service at a processing point; the user's providing interactive menu response information according to the interactive menu; and the user's resuming the requested service with the interactive menu response information from the processing point at which the requested service was suspended.

### BACKGROUND OF THE INVENTION

1. Field of the Invention

The field of the invention is data processing, or, more specifically, methods, systems, and products for transmission of interactive menus.

2. Description of Related Art

The current voice response technology allows a user to conduct a transaction by telephone by selecting menu options in response to voice prompts of an interactive menu using either the keypad or voice response. When transactions become complex, however, for example, when entering addresses, names, product description, contact information, and the like, the interface becomes convoluted. Often it is difficult or even impossible to request that kind of information through interactive menus of a voice response system (‘VRS’) or calling service. Since the VRS interface is so limited, then either a call to a live operator must be made, or the user may have to resort to conducting the transaction over the Web. Another problem with the current technology is that the user remains in the call-in queue for a considerable time until a live operator is able to obtain the necessary operation.

### SUMMARY OF THE INVENTION

Methods, systems, and products are disclosed that operate generally to allow a user to call in to a calling service at a telephone number and interact with a VRS to a point where an interactive menu can be requested, where such a menu is automatically sent to the user's mobile phone or other designated telecommunication device for processing. More particularly, methods, systems, and products are disclosed for transmission of interactive menus that include a user's requesting, by a call to a call service, a service of the call service, the call service including services, a voice response system, and one or more interactive menus; receiving in a telecommunication device from the call service an interactive menu, including suspending the requested service at a processing point; the user's providing interactive menu response information according to the interactive menu; and the user's resuming the requested service with the interactive menu response information from the processing point at which the requested service was suspended.

In typical embodiments, the interactive menu includes a service identifier that identifies the requested service and a processing point identifier that identifies the processing point where the requested service is suspended. In typical embodiments, receiving the interactive menu may include terminating the call. In typical embodiments, the user's providing interactive menu response information through the telecommunication device according to the interactive menu may be carried out asynchronously with respect to the call to the call service. In typical embodiments, the user's resuming the requested service may be carried out by transmitting to the call service an interactive menu response message including the interactive menu response information.

Methods, systems, and products disclosed in this specification for transmission of interactive menus include receiving in a call service, by a call from a user, a request for a requested service of the call service, the call service including services, a voice response system, services, and one or more interactive menus; transmitting from the call service to a telecommunication device an interactive menu, including suspending the requested service at a processing point; receiving an interactive menu response message containing interactive menu response information specified according to the interactive menu; and resuming the requested service from the processing point at which the requested service was suspended with the interactive menu response information.

In typical embodiments, suspending the requested service may include storing by the call service the state of the requested service, including storing a service identifier that identifies the requested service and a processing point identifier that identifies the processing point where the requested service is suspended. In typical embodiments, the interactive menu includes a service identifier that identifies the requested service and a processing point identifier that identifies the processing point where the requested service is suspended. In typical embodiments, transmitting the interactive menu may include terminating the call. In typical embodiments, receiving an interactive menu response message may be carried out asynchronously with respect to the call to the call service.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a diagram illustrating an exemplary system for transmission of interactive menus according to embodiments of the present invention.

FIG. 2 sets forth a block diagram of an exemplary computer useful in systems for transmission of interactive menus according to embodiments of the present invention.

FIG. 3 sets forth a data structure diagram illustrating exemplary data structures useful in systems for transmission of interactive menus according to embodiments of the present invention.

FIG. 4 sets forth a flow chart illustrating an exemplary method for transmission of interactive menus according to embodiments of the present invention.

FIG. 5 sets forth a flow chart illustrating a further exemplary method for transmission of interactive menus according to embodiments of the present invention.

### DETAILED DESCRIPTION OF EXEMPLARY EMBODIMENTS

### Introduction

The present invention is described to a large extent in this specification in terms of methods for transmission of interactive menus. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Glossary of Terms

Subject to the context of usage, the following terms are used generally in this specification as defined here:

A ‘browser’ or ‘Web browser’ is a data communications software application used to locate and display Web pages. Examples of browsers include Netscape Navigator™ and Microsoft Internet Explorer™. Most modern browsers can present multimedia information, including sound and video, although they may require plug-ins for some formats.

‘WSDL’ refers to the Web Services Description Language, an XML-formatted language used to describe a Web service's capabilities as collections of communication endpoints capable of exchanging messages. WSDL is an integral part of UDDI, an XML-based worldwide business registry. WSDL was developed jointly by Microsoft and IBM.

‘HDTP’ is the Handheld Device Markup Language, used to format content for Web-enabled mobile phones. HDML (Handheld Device Markup Language) is Openwave's proprietary language, which can only be viewed on mobile phones that use Openwave browsers. HDML came before the WAP standard was created. It uses Openwave's HDTP instead of WAP.

‘XML’ is the Extensible Markup Language, a specification developed by the W3C. XML is a pared-down version of SGML, designed especially for Web documents. It allows designers to create their own customized tags, enabling the definition, transmission, validation, and interpretation of data between applications and between organizations.

‘WML’ is the Wireless Markup Language, an XML language used to specify content and user interface for WAP devices. The WAP forum provides a DTD (XML Document Type Definition) for WML. WML is supported by most mobile phone browser and microbrowsers around the world.

“WAP” refers to the Wireless Application Protocol, a protocol for use with handheld wireless devices. Examples of wireless devices useful with WAP include mobile phones, pagers, two-way radios, and hand-held computers. WAP supports many wireless networks, and WAP is supported by many operating systems. Operating systems specifically engineered for handheld devices include PalmOS, EPOC, Windows CE, FLEXOS, OS/9, and JavaOS. WAP devices that use displays and access the Internet run “microbrowsers.” The microbrowsers use small file sizes that can accommodate the low memory constraints of handheld devices and the low-bandwidth constraints of wireless networks.

‘HTML’ refers to the ‘HyperText Markup Language,’ a markup language for displaying web pages on browsers.

‘HTTP’ refers to the ‘HyperText Transport Protocol,’ a data communications protocol of the World Wide Web.

‘PSTN’ is the Public Switched Telephone Network, which refers to the international telephone system based on copper wires carrying analog voice data. This is in contrast to newer telephone networks base on digital technologies, such as ISDN and FDDI. Telephone service carried by the PSTN is often called plain old telephone service (‘POTS’).

‘VOIP’ refers to the Voice Over Internet Protocol, a category of hardware and software that enables people to use the Internet as the transmission medium for telephone calls by sending voice data in packets using IP rather than by traditional circuit transmissions of the PSTN. One advantage of VOIP is that the telephone calls over the Internet do not incur a surcharge beyond what the user is paying for Internet access, much in the same way that the user doesn't pay for sending individual e-mails over the Internet. VOIP also is sometimes referred to as Internet telephony, IP telephony, or Voice over the Internet (VOI)

“SMS” is an abbreviation for Short Message Service. SMS is a protocol and service for sending short text messages to mobile phones.

“TCP/IP” means the Transmission Control Protocol (TCP) and the Internet Protocol (IP) operating together. TCP/IP is a packet switching protocol. TCP establishes a virtual connection between a data source and a data destination. IP specifies that data will be sent from the source to the destination in packets and IP specifies the addressing scheme of the source and the destination. TCP monitors the delivery of the data and the order in which the packets are delivered.

‘DTMF’ stands for Dual Tone Multi-Frequency, the system used by touch-tone telephones. DTMF assigns a specific frequency (consisting of two separate tones) to each key of keypad so that it can easily be identified by a microprocessor.

“World Wide Web,” or more simply “the web,” refers to a system of internet protocol (“IP”) servers that support specially formatted documents, documents formatted in markup languages such as HTML, XML (eXtensible Markup Language), WML (Wireless Markup Language), or HDML (Handheld Device Markup Language). The term “Web” is used in this specification also to refer to any server or connected group or interconnected groups of servers that implement a hyperlinking protocol, such as HTTP or WAP (the ‘Wireless Access Protocol’), in support of URLs and documents in markup languages, regardless of whether such servers or groups of servers are coupled to the World Wide Web as such.

### Transmission of Interactive Menus

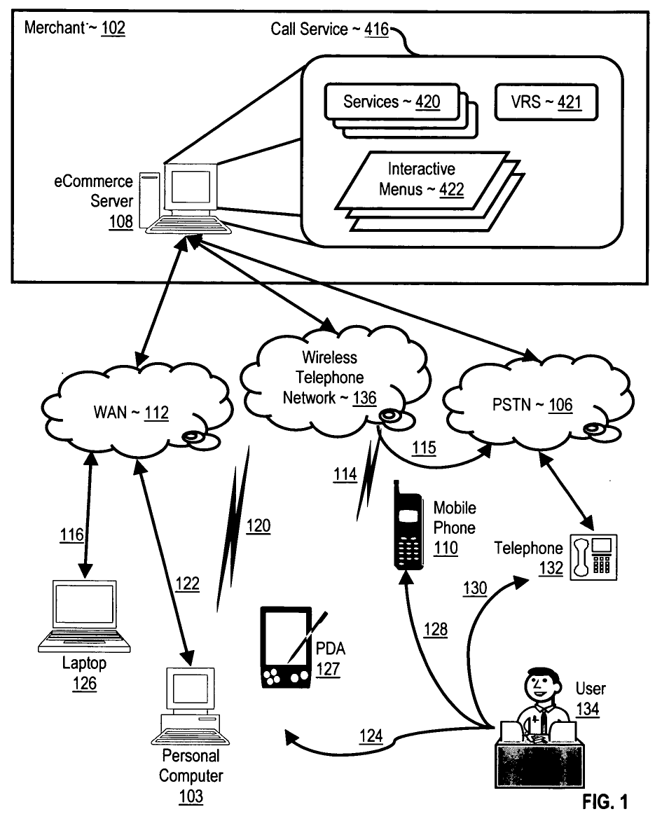

Exemplary methods, systems, and products for transmission of interactive menus according to embodiments of the present invention are described with reference to the accompanying drawings, beginning with FIG. 1. FIG. 1 sets forth a diagram illustrating an exemplary system for transmission of interactive menus according to embodiments of the present invention. Systems for transmission of interactive menus according to embodiments of the present invention operate generally to make available off-line interactive menus from call services so that a user can provide menu response information through the interactive menu at the user's convenience. The user generally may maintain a communications connection to the call service or terminate the connection. That is, the user may provide response information through a downloaded interactive menu during the initial call. Or the user may terminate the initial call, enter the response information off-line, and submit the response information later, ‘asynchronously’ with respect to any call to the call service. A connection to a call service in this specification is referred to generally as a ‘call.’ The call is typically a telephone call of some kind, although the terms need to be used in a general sense because it includes more than just a traditional PSTN call from a traditional telephone. The term ‘call’ in this specification includes wireline calls through PSTN, wireless calls through a wireless network or through a wireless network combined with PSTN, VOIP calls, and others as will occur to those of skill in the art.

The download of an interactive menu is carried out generally through digital data communications such as, for example, communications by HTTP, WAP, HDTP, SMS, and the like, in messages containing the interactive menu encoded in the form of XML, HTML, HDML, WML, and so on as will occur to those of skill in the art. There is no requirement that the interactive menu be sent to the user's telecommunication device that called the call service. The transmission of the interactive menu again is asynchronous with respect to the call to the call service. There is no requirement that the download be carried out during the call to the call service, for example. The download may be requested during the call and received later on user equipment other than the telecommunication device that placed the call to the call service.

The system of FIG. 1 includes a merchant (102) establishment that includes an ecommerce server (108) which installed and operating upon it a call service (416). The call service (416) includes a voice response system (‘VRS’) (421), services (420), and one or more interactive menus (422). A ‘service’ is any use that can be automated and accessed through a voice response menu, including, for example, another voice response menu. Examples of services include online driving license renewals, online marketing services (product description, product selection, order entry, payment and delivery arrangements), customer service functions, customer product help functions, and so on as will occur to those of skill in the art. A voice response system operates interactive menus to interact with users to provide services. A voice response system presents menu items in the form of prompts audible to users who access the voice response system by calling it.

A call to the call service at 1-800-IBM-SERV, for example, encounters the following interactive menu provided through a voice response system:
Thank you for calling IBM. Your call may be monitored or recorded for quality purposes.
If you are calling for hardware service support, press or say ‘one.’
If you are calling for IBM software support services, press or say ‘two.’
For sales or general information about the IBM Corporation, press or say ‘three.’
If you are an IBM business continuity and recovery services customer and you are declaring a disaster or outage emergency, press or say ‘four.’

Interactive menu response data for this interactive menu from IBM is a digit between ‘one’ and ‘four.’ Because this menu prompts for ‘press,’ its call service apparently supports DTMF detection for response data. Because this menu prompts alternatively for ‘say,’ its call service apparently supports voice recognition for response data. The services provided through the menu are automated connections to the merchant's representatives, in this example, IBM's customer representatives in the four categories hardware support, software support, general information, and continuity services.

From the point of view of the call service, the system of FIG. 1 functions generally for transmission of interactive menus according to embodiments of the present invention by receiving in a call service (416), by a call from a user (134), a request for a requested service (one of the supported services (420)) of the call service; transmitting to a telecommunication device (126, 103, 127, 110, 132) from the call service an interactive menu (422), including suspending the requested service at a processing point; receiving an interactive menu response message containing interactive menu response information specified according to the interactive menu; and resuming the requested service from the processing point at which the requested service was suspended with the interactive menu response information. The user may optionally terminate the call while providing the interactive menu response information offline through the interactive menu. Because the interactive menu may be administered offline—from the call service, the call service may receive an interactive menu response message asynchronously with respect to the call to the call service.

From the point of view of the user, the system of FIG. 1 functions generally for transmission of interactive menus according to embodiments of the present invention by a user's (134) requesting, by a call to the call service (416), a requested service (420) of the call service; receiving in a telecommunication device (126, 103, 127, 110, 132) from the call service an interactive menu (422), including suspending the requested service at a processing point; the user's providing interactive menu response information according to the interactive menu; and the user's resuming the requested service with the interactive menu response information from the processing point at which the requested service was suspended. There is no requirement that the telecommunication device that receives the interactive menu be the same device that was used to call the call service. The user may optionally terminate the call while providing the interactive menu response information offline through the interactive menu. The user may resume the requested service by transmitting from a telecommunication device to the call service an interactive menu response message including the interactive menu response information. Because the interactive menu can be administered offline from the call service, the user may provide interactive menu response information through the telecommunication device according to the interactive menu asynchronously with respect to the call to the call service.

In the system of FIG. 1, a user may place a call to a call service by VOIP, wireless telephone, or PSTN through:
a laptop computer (126) connected for electronic communications to ecommerce server (108) in merchant (102) through wireline connection (116) and Wide Area Network (‘WAN’) (112);
a personal computer (103) connected for electronic communications to ecommerce server (108) in merchant (102) through wireline connection (122) and Wide Area Network (‘WAN’) (112);
a personal digital assistant (‘PDA’) (127) connected for electronic communications to ecommerce server (108) in merchant (102) through wireless connection (120) and Wide Area Network (‘WAN’) (112).
a mobile telephone (110) connected for electronic communications to ecommerce server (108) in merchant (102) through wireless connection (114) and Wireless Telephone Network (136)—and alternatively also through PSTN (106, 115);
and, of course, through telephone handset (132) connected for electronic communications to ecommerce server (108) in merchant (102) through PSTN (106).

As mentioned above, there is no requirement that the interactive menu be sent to the same telecommunication device used for the initial call to the call service. The user may begin an interaction with the call service by a call from a telephone (132) or a mobile phone (110) and request a download of an interactive menu to be sent to a personal computer (103), a laptop (126), or a PDA (127), for example.

The call service may transmit an interactive menu to any of the illustrated telecommunications devices (126, 103, 127, 110, 132) as well as others that will occur to those of skill in the art. The interactive menus may be transmitted as plain text or as markup documents. Markup languages useful to implement transmissions of interactive menus in systems according to embodiments of the present invention include, for example, HTML, WML, and XML. Data communications protocols useful to transmit interactive menus in electronic form in systems for transmission of interactive menus according to embodiments of the present invention include, for example, HTTP, WAP, SMS, TCP, and the IP.

Telecommunications device may be adapted to operate transmitted interactive menus according to embodiments of the present invention, for example, by adapting their telecommunication client software, browsers, microbrowsers, and the like, to present interactive menus and gather and transmit interactive menu response information. Alternatively, telecommunications devices may be adapted to operate transmitted interactive menus according to embodiments of the present invention, for example, by adapting them to include DTMF detection, voice recognition, and text to speech (TTS) capability for presenting interactive menus downloaded in the form of text prompts with name/value fields for interactive menu response information.

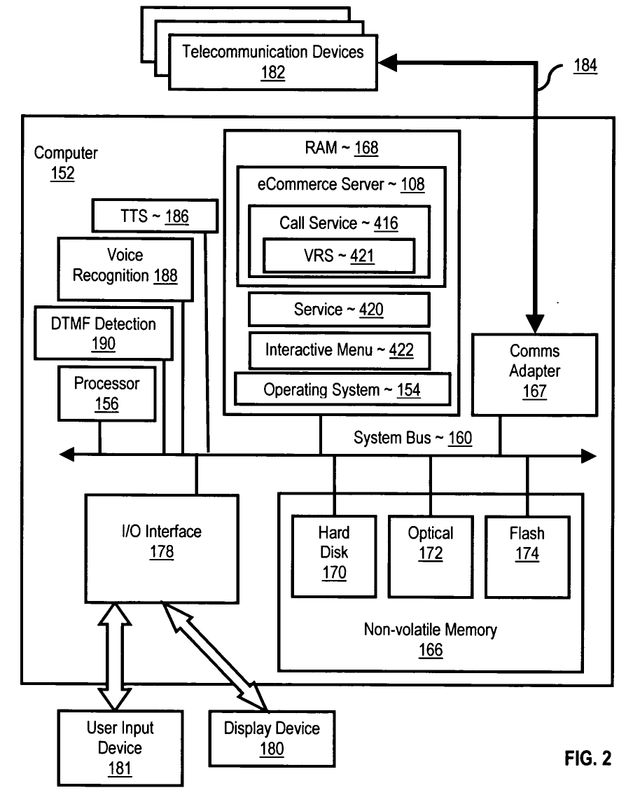

Systems for transmission of interactive menus according to embodiments of the present invention are generally implemented with automated computing machinery, that is, with computers. In the system of FIG. 1, for example, several principal components are represented primarily as computers, including telecommunications devices (126, 103, 127, 110, 132), the ecommerce server (108), and the call service (416). For further explanation of automated computing machinery, therefore, FIG. 2 sets forth a block diagram of an exemplary computer (152) useful in systems for transmission of interactive menus according to embodiments of the present invention.

The computer (152) of FIG. 2 includes at least one computer processor (156) or ‘CPU’ as well as random access memory (168) (“RAM”). Stored in RAM (168) is software, program instructions, for an ecommerce server (108) that includes a call service (416) and a voice response system (VRS) (421). Also stored in RAM for use by the call service are at least one service (420) and at least one interactive menu (422). Processor (156), the stored programs in RAM (108, 416, 421, 420, 422), and communications adapter (167) work together to carry out transmissions of interactive menus according to embodiments of the present invention. That is, these elements operate to receive in a call service (416), by a call from a user, a request for a requested service (one of the services (420)) of the call service; transmit to a telecommunication device (182) from the call service an interactive menu (422), while suspending the requested service at a processing point; receive an interactive menu response message containing interactive menu response information specified according to the interactive menu; and resume the requested service from the processing point at which the requested service was suspended with the interactive menu response information.

Telecommunications devices (182) represented also as automated computing machinery bear processors, stored programs in RAM, and communications adapters, similar to those illustrated in FIG. 2, that operate together to carry out transmissions of interactive menus according to embodiments of the present invention by receiving user's requests for a requested service (420) of the call service; receiving in a telecommunication device (182) from the call service (416) an interactive menu (422), including suspending the requested service at a processing point; providing from a telecommunication device interactive menu response information according to the interactive menu; and resuming the requested service with the interactive menu response information from the processing point at which the requested service was suspended.

Also stored in RAM (168), in the example of FIG. 2, is an operating system (154). Operating systems useful in computers, ecommerce servers, and telecommunications devices according to embodiments of the present invention include Unix™, Linux™, AIX™, Microsoft NT™, and others as will occur to those of skill in the art. In the example of FIG. 2, the ecommerce server (108), the call service (416), and the operating system (154) are shown in RAM (168), although many components of such software may also be stored in non-volatile memory (166).

The computer (152) of FIG. 2 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of non-volatile computer memory as will occur to those of skill in the art.

The exemplary computer (152) of FIG. 2 includes a communications adapter (167) for implementing connections for data communications (184), including connections through networks, to other telecommunications devices (182), including, for example, the telecommunications devices of FIG. 1 (126, 103, 127, 110, 132) and others as will occur to those of skill in the art. Communications adapters implement the hardware level of connections for data communications through which one computer sends data communications another computer, directly or through a network. Examples of communications adapters useful for transmission of interactive menus according to embodiments of the present invention include modems for wired dial-up connections, Ethernet (IEEE 802.3) adapters for wired network connections, and 802.11b adapters for wireless network connections.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards, mice, numeric keypads for DTMF input, magnetic card readers, and microphones for voice input.

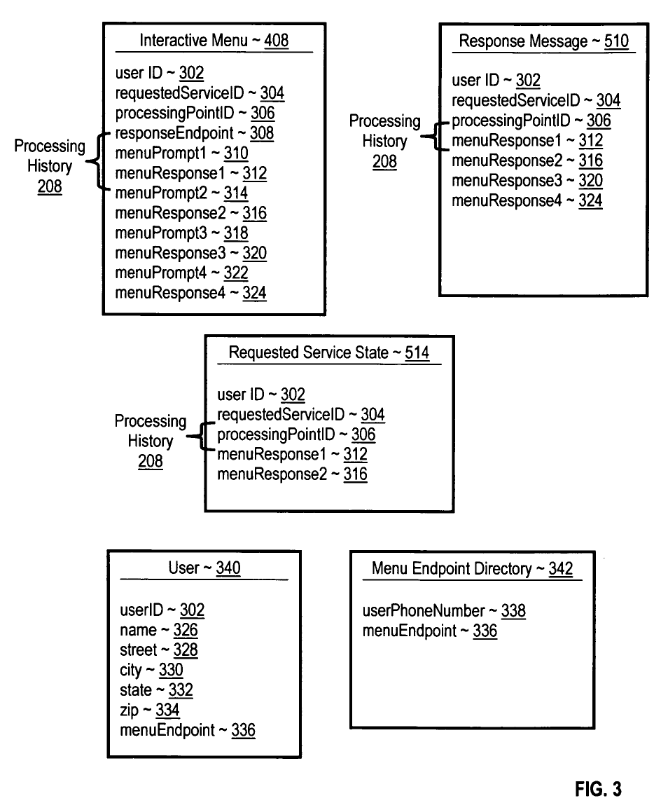

For further explanation, FIG. 3 sets forth a data structure diagram illustrating exemplary data structures useful in systems for transmission of interactive menus according to embodiments of the present invention. The examples of FIG. 3 are for explanation only, not for limitation of the present invention. Many data structures and data models as will occur to those of skill in the art are useful in systems for transmission of interactive menus according to embodiments of the present invention.

The exemplary data structures of FIG. 3 include a structure representing an interactive menu (408). The interactive menu (408) includes a user identifier field (302) that stores a unique identification code for a user. The identification code may be retained in a user record in an ecommerce server, assigned during a call to a call service, entered at behest of the user, or determined in other ways as will occur to those of skill in the art. The interactive menu (408) includes a field named requestedServiceID (304) in which is stored an identifier for a requested service, the service that is suspended when the interactive menu is transmitted to a telecommunication device. The interactive menu (408) includes a field named processingPointID (306) in which is stored an identifier of the processing point where the requested service was suspended when the interactive menu is transmitted to a telecommunications device. The interactive menu (408) includes fields named menuPrompt1 (310), menuPrompt2 (314), menuPrompt3 (318), and menuPrompt4 (322) in which are stored four text prompts for four menu items. The interactive menu (408) includes fields named menuResponse1 (312), menuResponse2 (316), menuResponse3 (320), and menuResponse4 (324) that provide storage for interactive menu response information—which may be implemented, for example, as the name portion of name-value pairs.

The exemplary data structures of FIG. 3 include a structure representing an interactive menu response message (510). The response message (510) includes a user identifier field (302) that stores a unique identification code for a user. The value of the user identifier field (302) in the response message is taken from the user identifier field in a corresponding interactive menu when the interactive menu is received by a user in a telecommunications device. The response message (510) includes a field named requestedServiceID (304) in which is stored an identifier for a requested service, the service that was suspended when a corresponding interactive menu is transmitted to a telecommunication device. The value of requestedServiceID also is taken from a corresponding interactive menu when received in a telecommunications device. The response message (510) includes a field named processingPointID (306) in which is stored an identifier of the processing point where the requested service was suspended when the interactive menu is transmitted to a telecommunications device, whose value also is taken from a corresponding interactive menu when received in a telecommunications device.

The response message (510) also includes fields named menuResponse1 (312), menuResponse2 (316), menuResponse3 (320), and menuResponse4 (324) that provide storage for interactive menu response information. The response message is constructed in and transmitted from a telecommunications device. A user provides interactive menu response information as data entry in response to menu prompts of an interactive menu on a telecommunications device. The response message is constructed using the menu response information provided by the user. The response information may be encoded in the menuResponse fields (312, 316, 320, 324) as name-value pairs, now with the values filled in by the interactive menu response information as entered by the user.

In the example of FIG. 3, the interactive menu (408) is illustrated with four menuPrompt fields (310, 314, 318, 322), and both the interactive menu (416) and the response message (510) are illustrated with four menuResponse fields (312, 316, 320, 324). The number four in these examples is for explanation only, not a limitation of the invention. Moreover, the illustration of interactive menu and response messages with prompt and response fields is for explanation only, not a limitation of the invention. In fact, there are many other ways as will occur to those of skill in the art for representing interactive menus and response messages, including, for example, HTML documents, XML documents, WML documents, HDML documents, plain text, and so on, and all such ways are well within the scope of the present invention.

When a requested service is suspended upon transmission of a corresponding interactive menu, when pertinent interactive menu response information is transmitted to the call service, the requested service is resumed at the processing point where it was suspended. The interactive menu may be administered asynchronously and even offline from the call service, so that in suspending the requested service, it is useful to maintain its state in computer storage until return of the response information. The service may even be terminated entirely and resumed from scratch upon arrival of the response information—so that it is useful to be able to advise the service where it left off.

The exemplary data structures of FIG. 3 include a structure representing the state of a requested service (514). Each instance of a requested service state (514) may represent the state of a requested service at the time when it was suspended when a corresponding interactive menu was transmitted to a user. The requested service state (514) includes a user identifier field (302) that stores a unique identification code for a user. The value of the user identifier field (302) in the requested service state is taken as the user identifier of the user to whom a corresponding interactive menu is transmitted. The requested service state (514) includes a field named requestedServiceID (304) in which is stored an identifier for the suspended requested service, the service that was suspended when a corresponding interactive menu is transmitted to a telecommunication device. The requested service state (514) includes a field named processingPointID (306) in which is stored an identifier for the processing point where the requested service was suspended when the interactive menu is transmitted to a telecommunications device.

The requested service state (514) also includes fields named menuResponse1 (312) and menuResponse2 (316), that provide storage for interactive menu response information that represents the processing history (208) of the requested service up to the processing point where it was suspended. The processing history (208), in this example, is a list of the interactive menu response information entered by the user prior to transmission of an interactive menu to the user and suspension of the requested service. Storing the processing history as part of the requested service state advantageously supports the requested service in resuming service by avoiding any need to reenter response information already provided in previous processing steps.

Interactive menu (408), response message (510), and requested service state (514), considered together, illustrate two ways of maintaining the state of a requested service across asynchronous calls to call services, communications of interactive menus, and transmissions of response messages, and resumption of a requested service. This example assumes for the sake of explanation that menuPrompt1 (310), menuRepsonse1 (312), menuPrompt2 (314), and menuRepsonse2 (316) make up a processing history (208) for a requested service. In such an example, the state of the requested service, identified by requestedServiceID (304), upon suspension may be represented by the values of processingPointID (306), menuResponse1 (312) and menuResponse2 (316). If the processing point upon which the requested process was suspended was menuPrompt2, for example, then the value of processingPointID (306) would be a code representing or identifying menuPrompt2 as the processing point where the requested service was suspended.

In this example, the interactive menu (408) and response message (510) illustrate a first way of maintaining the state of a requested service by, in effect, passing the state around to and from a telecommunications device within the interactive menu (408) and the response message (510) themselves. That is, by including the values of processingPointID (306), menuResponse1 (312) and menuResponse2 (316) in the interactive menu (408) when it is transmitted to a user's telecommunication device for interactive administration, a call service records in the interactive menu the state of the requested service upon suspension. The call service may then suspend the requested service with no need to record the state of the requested service in the call service or the ecommerce server. When the requested service resumes, the requested service can read its state (306, 312, 316) from the response message (510), retrieve the additional interactive menu response information (320, 324) from the received response message (510), and continue processing where it left off when it was suspended.

The requested service state structure (514) illustrates a second way of maintaining the state of a requested service with the ecommerce server or the call service itself. That is, the call service, upon suspending a requested service, stores the state of the service in a structure similar to the example requested service state (514). When the requested service resumes, the requested service, knowing its own identification or requestedServiceID can read its state (306, 312, 316) from the requested service state records (514) in the call service, retrieve the additional interactive menu response information (320, 324) from the received response message (510), and continue processing where it left off when it was suspended.

The exemplary data structures of FIG. 3 include a structure for a record representing a user (340). A call service may maintain such records because the user is known to the call service as a registered subscriber or customer, for example. A user record (340) may include fields for a user identification code (302), the user's name (326), the user's address (328, 330, 332, 334), and other user-related fields as will occur to those of skill in the art. This example user record (340) also includes a field named menuEndpoint (336) that identifies a data communications endpoint of a telecommunications device to which an interactive menu may be transmitted for the user identified in the record. A data communications endpoint may be identified by an encoding of a network address optionally combined with an identifier of a telecommunications software program on a telecommunications device, often referred to as a ‘port number.’ A network address may be encoded as:
a URL (Universal Resource Identifier), for example: www.someDevice.com/myScript.cgi,
a mailto URL, for example: 5128381449@someDevice.com,
a raw network address such as a dotted decimal IP address, for example: 66.135.192.87,
a WSDL web services endpoint, for example: <wsdl:endpoint name=“telComDev” wsdm:target=“urn:myProg”>,
a telephone number, and
other encodings as will occur to those of skill in the art.

A call service that has a user record for a user who calls the service may identify a data communications endpoint of a telecommunications device to which an interactive menu may be transmitted for the user identified in the record by looking up the menuEndpoint for the user in dependence upon the user's userID in user records like the one illustrated at reference (340) on FIG. 3.

The exemplary data structures of FIG. 3 include a structure representing a record in a menu endpoint directory (342). A menu endpoint directory may be maintained as a service of an ecommerce server in a merchant or in a user's telephone company, for example. The menu endpoint directory record (342) includes a field named userPhoneNumber (338) that stores a user's telephone number, landline number, a mobile number, or any other kind of number. The menu endpoint directory record (342) includes a field named menuEndpoint (336) that identifies a data communications endpoint of a telecommunications device to which an interactive menu may be transmitted for the user identified in the record. A call service that has no user record for a user who calls the service may identify a data communications endpoint of a telecommunications device to which an interactive menu may be transmitted for the user identified in the record by reading the user's telephone number from the callerID data for the call and looking up the menuEndpoint for the user in dependence upon the user's telephone number in a menu endpoint directory having records like the one illustrated at reference (342) on FIG. 3.

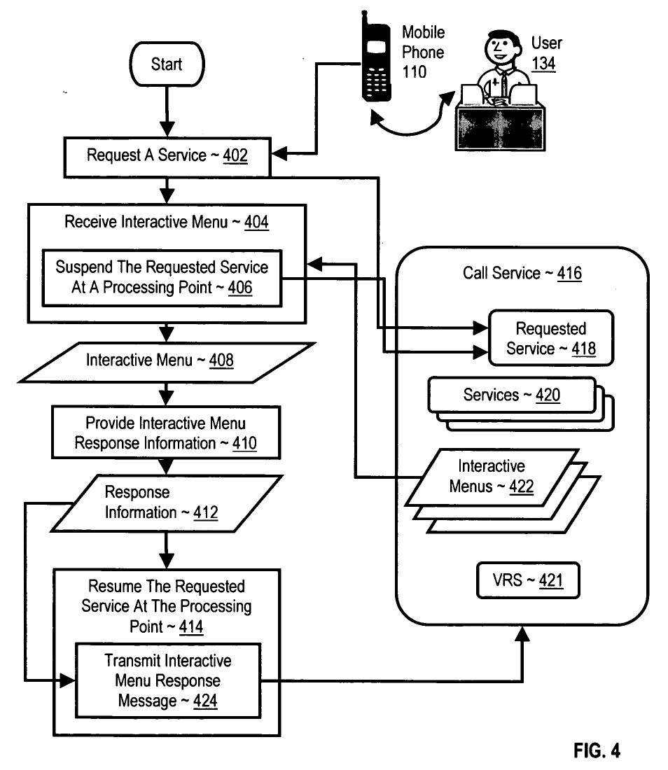

For further explanation, FIG. 4 sets forth a flow chart illustrating an exemplary method for transmission of interactive menus according to embodiments of the present invention that includes a user's (134) requesting (402), by a call to a call service (416), a requested service (418) of the call service. In the example of FIG. 4, the call service includes services (420), a voice response system (421), and one or more interactive menus (422). In the example of FIG. 4, the user's telecommunication device is represented as a mobile telephone, although as described above, the telecommunication device may be implemented as any number of devices, PDAs, laptop computers, telephone handsets, and so on.

In the example of FIG. 4, the processing steps (402, 404, 410, 414, and so on) are described as though they are carried out in or through a single user telecommunication device (110), although as mentioned above, this is not a limitation of the present invention. Alternatively, for example, a user may request a service of a call service and request a download of an interactive menu to some device other than the device on which the user made the call. The call service may download the interactive menu to a communications endpoint from the other device, and the user can provide menu response data through the other device. A manager may request through a mobile phone a download of an interactive menu to a workstation on a secretary's desk, for example. Then the secretary can provide interactive menu response data by operating the interactive menu on the workstation on the secretary's desk.

The method of FIG. 4 also includes receiving (404) in a telecommunication device from the call service an interactive menu (408). In the method of FIG. 4, the interactive menu may include a service identifier (304 on FIG. 3) that identifies the requested service and a processing point identifier (306 on FIG. 3) that identifies the processing point where the requested service is suspended. In the method of FIG. 4, receiving (404) an interactive menu (408) includes suspending (406) the requested service at a processing point. The method of FIG. 4 also includes the user's providing (410) interactive menu response information (412) according to the interactive menu (408). The user may operate the interactive menu on the telecommunication device to which the interactive menu was transmitted by a calling service, or the user may move the interactive menu to another device.

In the method of FIG. 4, the user's providing (410) interactive menu response information through the telecommunication device according to the interactive menu may be carried out asynchronously with respect to the call to the call service. That is, in the method of FIG. 4, receiving (404) the interactive menu may include terminating the call. The user may hold the call open while receiving and operating the interactive menu, or the user may terminate the call and call back to the call service if necessary after completing the interactive menu.

The method of FIG. 4 also includes the user's resuming (414) the requested service (418) with the interactive menu response information (412) from the processing point at which the requested service (418) was suspended, which may be carried out by the user's transmitting (424) from a telecommunication device to the call service an interactive menu response message including the interactive menu response information (412).

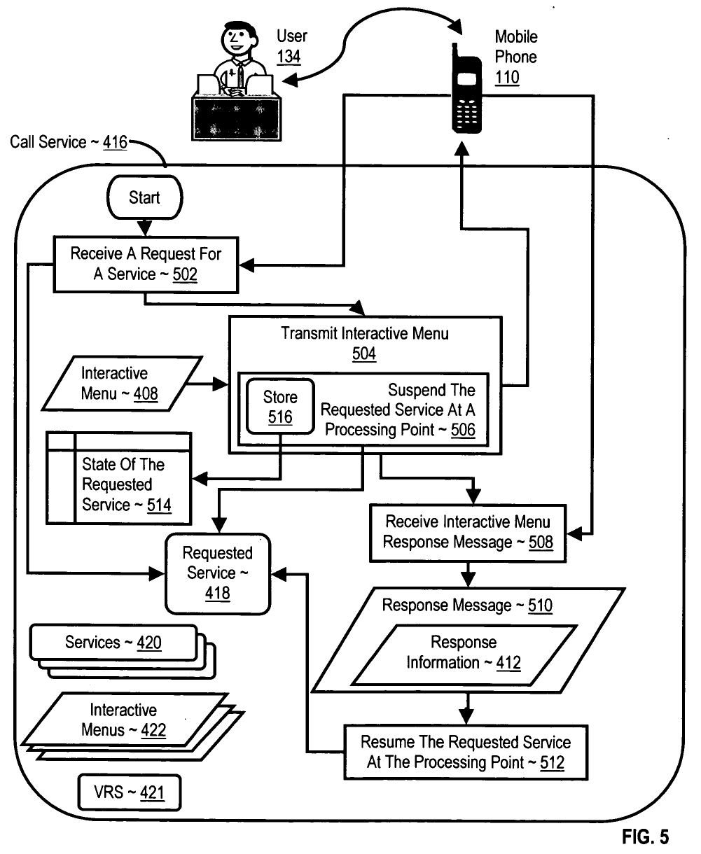

For further explanation, FIG. 5 sets forth a flow chart illustrating a further exemplary method for transmission of interactive menus according to embodiments of the present invention that includes receiving (502) in a call service (416), by a call from a user (134), a request for a requested service (418) of the call service. In the example of FIG. 5, the call service includes services (420), a voice response system (421), and one or more interactive menus (422). In the example of FIG. 5, the processing steps (502, 504, 508, 512, and so on) are carried out in or through the call service (416) operating in an ecommerce server such as the one illustrated at reference (108) on FIG. 1.

The method of FIG. 5 includes transmitting (504) to a telecommunication device (110) from the call service an interactive menu (408), including suspending (506) the requested service (418) at a processing point. In the method of FIG. 5, the interactive menu includes a service identifier (408, 304 on FIG. 3) that identifies the requested service and a processing point identifier (408, 306 on FIG. 3) that identifies the processing point where the requested service is suspended. In the method of FIG. 5, suspending (506) the requested service further comprising storing (516) by the call service the state (514) of the requested service, including storing a service identifier (514, 304 on FIG. 3) that identifies the requested service and a processing point identifier (514, 306 on FIG. 3) that identifies the processing point where the requested service is suspended. In the example of FIG. 5, a user's telecommunication device (110) is represented as a mobile telephone, although as described above, a telecommunication device may be implemented as any number of devices, PDAs, laptop computers, telephone handsets, and so on.

The method of FIG. 5 includes receiving (508) an interactive menu response message (510) containing interactive menu response information (412) specified according to the interactive menu (408). In the method of FIG. 5, receiving (508) an interactive menu response message may be carried out asynchronously with respect to the call to the call service. That is, transmitting (504) the interactive menu may include terminating the call. The method of FIG. 5 includes resuming (512) the requested service (418), upon receiving (508) an interactive menu response message, from the processing point at which the requested service was suspended with the interactive menu response information (412).

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for transmission of interactive menus, the method comprising:
a user's requesting, by a call to a call service, a service of the call service, the call service comprising services, a voice response system, and one or more interactive menus;
receiving in a telecommunication device from the call service an interactive menu, including suspending the requested service at a processing point;
the user's providing interactive menu response information according to the interactive menu; and
the user's resuming the requested service with the interactive menu response information from the processing point at which the requested service was suspended.

2. The method of claim 1 wherein the interactive menu comprises a service identifier that identifies the requested service and a processing point identifier that identifies the processing point where the requested service is suspended.

3. The method of claim 1 wherein receiving the interactive menu further comprises terminating the call.

4. The method of claim 1 wherein the user's providing interactive menu response information through the telecommunication device according to the interactive menu further comprises the user's providing interactive menu response information through the telecommunication device according to the interactive menu asynchronously with respect to the call to the call service.

5. The method of claim 1 wherein the user's resuming the requested service further comprises the user's transmitting to the call service an interactive menu response message including the interactive menu response information.

6. A method for transmission of interactive menus, the method comprising:
receiving in a call service, by a call from a user, a request for a requested service of the call service, the call service comprising services, a voice response system, services, and one or more interactive menus;
transmitting from the call service to a telecommunication device an interactive menu, including suspending the requested service at a processing point;
receiving an interactive menu response message containing interactive menu response information specified according to the interactive menu; and
resuming the requested service from the processing point at which the requested service was suspended with the interactive menu response information.

7. The method of claim 6 wherein suspending the requested service further comprises storing by the call service the state of the requested service, including storing a service identifier that identifies the requested service and a processing point identifier that identifies the processing point where the requested service is suspended.

8. The method of claim 6 wherein the interactive menu comprises a service identifier that identifies the requested service and a processing point identifier that identifies the processing point where the requested service is suspended.

9. The method of claim 6 wherein transmitting the interactive menu further comprises terminating the call.

10. The method of claim 6 wherein receiving an interactive menu response message further comprises receiving an interactive menu response message asynchronously with respect to the call to the call service.

11. A system for transmission of interactive menus, the system comprising:
means for requesting, by a call to a call service, a service of the call service, the call service comprising services, a voice response system, and one or more interactive menus;
means for receiving in a telecommunication device from the call service an interactive menu, including means for suspending the requested service at a processing point;
means for providing interactive menu response information according to the interactive menu; and
means for resuming the requested service with the interactive menu response information from the processing point at which the requested service was suspended.

12. The system of claim 11 wherein the interactive menu comprises a service identifier that identifies the requested service and a processing point identifier that identifies the processing point where the requested service is suspended.

13. The system of claim 11 wherein means for receiving the interactive menu further comprises means for terminating the call.

14. The system of claim 11 wherein means for providing interactive menu response information through the telecommunication device according to the interactive menu further comprises means for providing interactive menu response information through the telecommunication device according to the interactive menu asynchronously with respect to the call to the call service.

15. The system of claim 11 wherein means for resuming the requested service further comprises means for transmitting to the call service an interactive menu response message including the interactive menu response information.

16. A system for transmission of interactive menus, the system comprising:
means for receiving in a call service, by a call from a user, a request for a requested service of the call service, the call service comprising services, a voice response system, services, and one or more interactive menus;
means for transmitting from the call service to a telecommunication device an interactive menu, including means for suspending the requested service at a processing point;
means for receiving an interactive menu response message containing interactive menu response information specified according to the interactive menu; and
means for resuming the requested service from the processing point at which the requested service was suspended with the interactive menu response information.

17. The system of claim 16 wherein means for suspending the requested service further comprises means for storing by the call service the state of the requested service, including means for storing a service identifier that identifies the requested service and a processing point identifier that identifies the processing point where the requested service is suspended.

18. The system of claim 16 wherein the interactive menu comprises a service identifier that identifies the requested service and a processing point identifier that identifies the processing point where the requested service is suspended.

19. The system of claim 16 wherein means for transmitting the interactive menu further comprises means for terminating the call.

20. The system of claim 16 wherein means for receiving an interactive menu response message further comprises means for receiving an interactive menu response message asynchronously with respect to the call to the call service.

21. A computer program product for transmission of interactive menus, the computer program product comprising:
a recording medium,
means, recorded on the recording medium, for requesting, by a call to a call service, a service of the call service, the call service comprising services, a voice response computer program product, and one or more interactive menus;
means, recorded on the recording medium, for receiving in a telecommunication device from the call service an interactive menu, including means, recorded on the recording medium, for suspending the requested service at a processing point;
means, recorded on the recording medium, for providing interactive menu response information according to the interactive menu; and
means, recorded on the recording medium, for resuming the requested service with the interactive menu response information from the processing point at which the requested service was suspended.

22. The computer program product of claim 21 wherein the interactive menu comprises a service identifier that identifies the requested service and a processing point identifier that identifies the processing point where the requested service is suspended.

23. The computer program product of claim 21 wherein means, recorded on the recording medium, for receiving the interactive menu further comprises means, recorded on the recording medium, for terminating the call.

24. The computer program product of claim 21 wherein means, recorded on the recording medium, for providing interactive menu response information through the telecommunication device according to the interactive menu further comprises means, recorded on the recording medium, for providing interactive menu response information through the telecommunication device according to the interactive menu asynchronously with respect to the call to the call service.

25. The computer program product of claim 21 wherein means, recorded on the recording medium, for resuming the requested service further comprises means, recorded on the recording medium, for transmitting to the call service an interactive menu response message including the interactive menu response information.

26. A computer program product for transmission of interactive menus, the computer program product comprising:
a recording medium;
means, recorded on the recording medium, for receiving in a call service, by a call from a user, a request for a requested service of the call service, the call service comprising services, a voice response computer program product, services, and one or more interactive menus;
means, recorded on the recording medium, for transmitting from the call service to a telecommunication device an interactive menu, including means, recorded on the recording medium, for suspending the requested service at a processing point;
means, recorded on the recording medium, for receiving an interactive menu response message containing interactive menu response information specified according to the interactive menu; and
means, recorded on the recording medium, for resuming the requested service from the processing point at which the requested service was suspended with the interactive menu response information.

27. The computer program product of claim 26 wherein means, recorded on the recording medium, for suspending the requested service further comprises means, recorded on the recording medium, for storing by the call service the state of the requested service, including means, recorded on the recording medium, for storing a service identifier that identifies the requested service and a processing point identifier that identifies the processing point where the requested service is suspended.

28. The computer program product of claim 26 wherein the interactive menu comprises a service identifier that identifies the requested service and a processing point identifier that identifies the processing point where the requested service is suspended.

29. The computer program product of claim 26 wherein means, recorded on the recording medium, for transmitting the interactive menu further comprises means, recorded on the recording medium, for terminating the call.

30. The computer program product of claim 26 wherein means, recorded on the recording medium, for receiving an interactive menu response message further comprises means, recorded on the recording medium, for receiving an interactive menu response message asynchronously with respect to the call to the call service.
